(19) United States
(12) Patent Application Publication
(10) Pub. No.: US 2002/0158457 A1
(43) Pub. Date: Oct. 31, 2002

(54) Passenger Restraint With Shoulder Belt Positioning System

(76) Inventor: John J. Simmons, Bismarck, ND (US)

Correspondence Address: James V. Harmon, 1000 Northstar Center East, 608 Second Avenue South, Minneapolis, MN, 55402, US

(21) Appl. No.: 09/480,566

(22) Filed: Jan. 10, 2000

(51) Int. Cl. B60R 22/00; B60R 22/48

(52) U.S. Cl. 280/801.1

(57) ABSTRACT

A passenger restraint has a lap belt and a shoulder belt. The lap belt extends across the lap between a vehicular bracket and a buckle which is secured to the vehicle. A shoulder belt extends from the buckle to an elevated vehicular bracket. A flexible positioning and retaining band encircles both belts in the lap area and is slidable on a generally horizontal axis across the lap of the user to hold the lap belt and shoulder belt proximate to one another between the band and the buckle. The lap belt and shoulder belt diverge at the band such that the shoulder belt extends upwardly to the elevated vehicular bracket at an angle determined by the lateral position of the band that has been selected. The band has a surface texture at least on the side that engages the belts to provide sufficient friction between the band and the belts so that the band remains in the location thereon that is selected by the user to maintain the shoulder belt in a comfortable position that does not chafe the user's body. The band can have overlapped ends secured together by a releasable fastening means such as a hook-and-loop Velcro® fastener on opposite surfaces.

### FIELD OF THE INVENTION

This invention relates to transportation and more particularly to passenger restraints.

### BACKGROUND OF THE INVENTION

Some existing vehicular seatbelts are designed with an apparatus at one anchor end of the shoulder belt that allows that end of the shoulder seatbelt to be raised or lowered to change the elevation at which the belt crosses the user's shoulder and chest. However, this apparatus is all too often not successful in keeping the shoulder belt from crossing the chest close to the user's neck, especially when the user is of medium or small stature or is a child. When the shoulder seatbelt crosses to join the waist belt high on a user's chest either close to or across the user's neck, the shoulder belt becomes very uncomfortable and in some cases irritates or chafes the neck area. To avoid the discomfort of a chafing shoulder belt, the user will sometimes place the shoulder belt under his or her arm or behind the back, but the seatbelt is then much less effective in providing protection to the user in the event of an accident or crash. When the belt is close to the neck of a small person or child, it can also cause serious injury to the user's neck if suddenly activated during an accident or crash. Consequently, there exists a need for an effective restraint system that makes it possible to easily change the angle at which a shoulder belt crosses the shoulder and chest to join with the lap or waist belt, and to allow the shoulder belt to cross the chest at a steeper angle and in a more comfortable position away from the neck.

In view of these and other deficiencies of the prior art, it is one object of the invention to provide a simple, low-cost, user-friendly passenger restraint that includes a shoulder belt positioning system which enables the passenger restraint to comfortably fit persons of large, medium or small stature without chafing any part of the body, such as the neck.

Another object of the invention is to provide a passenger restraint that allows a shoulder belt to be quickly and easily positioned by the user and then remain in the selected position.

A further object of the invention is to provide a shoulder belt positioning device which can be adjusted to accommodate passenger restraints of different sizes or can be placed in different vehicles.

A more specific object of the invention is to provide a passenger restraint with a positioning system which will not slip once placed in the desired position.

These and other more detailed and specific objects of the present invention will be better understood by reference to the following figures and detailed description which illustrate by way of example of but a few of the various forms of the invention within the scope of the appended claims.

### SUMMARY OF THE INVENTION

The invention provides a passenger restraint that includes a lap belt and a shoulder belt. The lap belt extends across the lap between a vehicular bracket and a buckle which is secured to the vehicle. The shoulder belt extends from the buckle to an elevated vehicular bracket. One or more of the brackets can be provided with an enclosed retractor mechanism of suitable known construction. A flexible positioning band encircles both belts in the lap area and is slidable on a generally horizontal axis across the lap of the user to hold the lap belt and shoulder belt proximate to one another between the band and the buckle. The lap belt and shoulder belt diverge at the positioning band so that the shoulder belt extends upwardly to the elevated vehicular bracket at an angle determined by the selected lateral position of the band. The band has a surface texture at least on the side that engages the belts to provide sufficient friction between the band and the belts such that the band remains in place and in the position that has been selected by the user to maintain the angle of inclination of the shoulder belt so that the shoulder belt is comfortable and does not chafe the neck or other part of the user's body. In one preferred form of the invention, the band is provided with a fastening means such as a hook-and-loop fastener on its inside and outside surfaces.

### THE FIGURES

FIG. 1 is a front elevational view showing one preferred form of the invention for use in a vehicle such as an automobile.

FIG. 2 is a side elevational view of a restraint band in accordance with the invention in an outstretched position.

FIG. 3 is a front elevational view of the band of FIG. 2.

FIG. 4 is a vertical cross-sectional view taken on line 4-4 of FIG. 1.

FIG. 5 is a side elevational view of another form of band in accordance with the invention.

FIG. 6 is a cross-sectional view similar to FIG. 4 showing the band of FIG. 5 encircling the seatbelts.

FIG. 7 is a modified form of flexible band, and

FIG. 8 is a perspective view of another form of band in accordance with the invention.

### DETAILED DESCRIPTION OF THE INVENTION

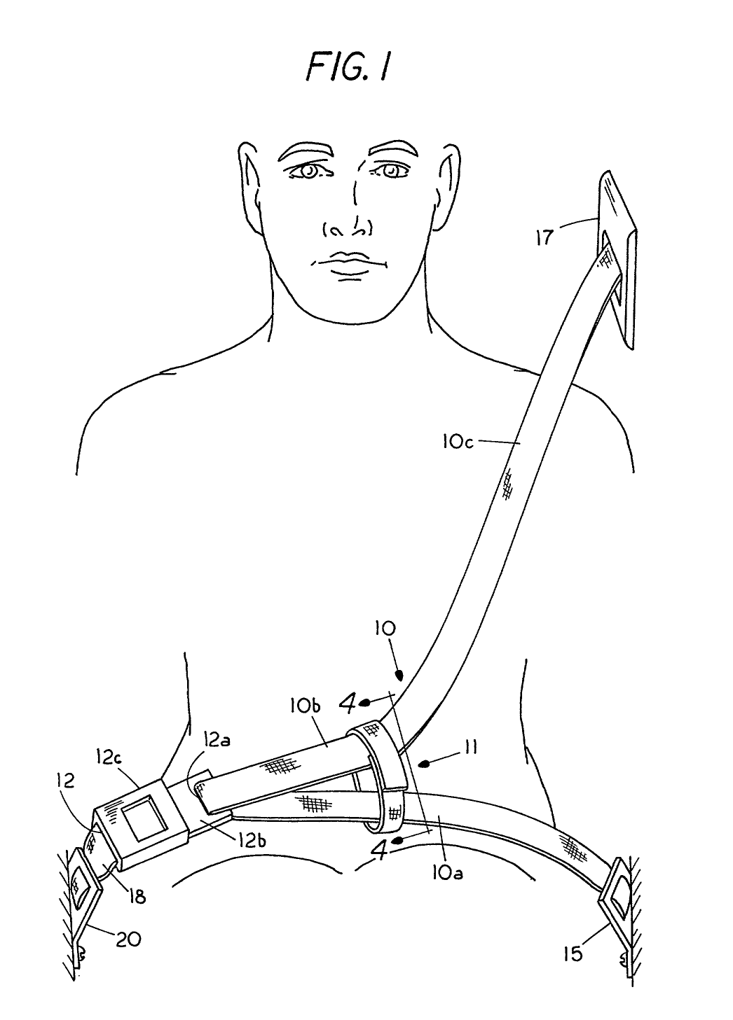

Refer now to the drawings and especially to FIG. 1 which show s a passenger restraint that can be used in any vehicle such as an automobile, bus, train or airplane. The restraint indicated generally at 10 is shown extending laterally across the lap of the vehicle occupant and upwardly over the left shoulder. Near the center of the passenger restraint 10 is a retention and positioning band 11 which will be described more fully below. The restraint 10 includes a belt formed from webbing, such as nylon webbing of conventional known construction having a lap or waist belt portion 10a and a shoulder belt portion 10b. The portions 10a and 10b can be thought of as a lap belt and a shoulder belt, although in this case they are portions of the same belt which extend through an opening 12a in a removable clip 12b which forms part of a buckle 12 of suitable known construction. The lap belt 10a is securely fastened at its right end, as seen in the figures, to a bracket 15 that is attached to the vehicle and serves as a vehicular anchoring point. The left end of the lap belt 10a, as already mentioned, extends through an opening 12a in the clip 12b. From the clip 12, the shoulder belt 10b extends upwardly and diagonally across the chest of the user to a vehicular anchoring point 17 which can, if desired, include a retractor mechanism of known construction for pulling the shoulder belt 10b upwardly and holding it securely in place during a crash. The clip 12b extends into housing 12c of the buckle 12 that is itself secured by means of a short length of strap material such as nylon webbing 18 to a bracket 20 which provides another vehicular anchoring point for the restraint 10. When the passenger restraint 10 is to be used, the clip 12b of the buckle 12 is pulled over the lap (from right to left in FIG. 1) and is connected to the housing portion 12c of the buckle 12. This draws both the lap belt 10a and the shoulder belt 10b across the front surface of the body of the user, substantially to the position shown in FIG. 1. While the upper anchoring point 17 has been shown as a belt retractor, either of the brackets 15 or 20 can, if desired, comprise a retractor of suitable known construction for keeping the restraint 10 in place on the body and for locking it securely in place to prevent the passenger from being thrown forwardly during a crash. Any suitable commercially available buckle 12, bracket 15, 20 or retractor mechanism can be employed for use with the restraint 10 of the present invention.

As already explained, the upper portion 10c of the shoulder belt 10b can become uncomfortable if it rubs on portions of the body and can often chafe the neck of the user, particularly if the user is of average or small stature or is a child. To prevent this, a flexible positioning and retention band 11 is provided to encircle and thereby enclose both the lap belt 10a and the shoulder belt 10b and to enable the shoulder belt 10b to be moved to a selected position. Thus, by sliding the band 11 toward the right in FIG. 1, the angular orientation of the shoulder belt 10b is changed as it crosses the user's chest and also moves the shoulder belt 10b away from the user's neck.

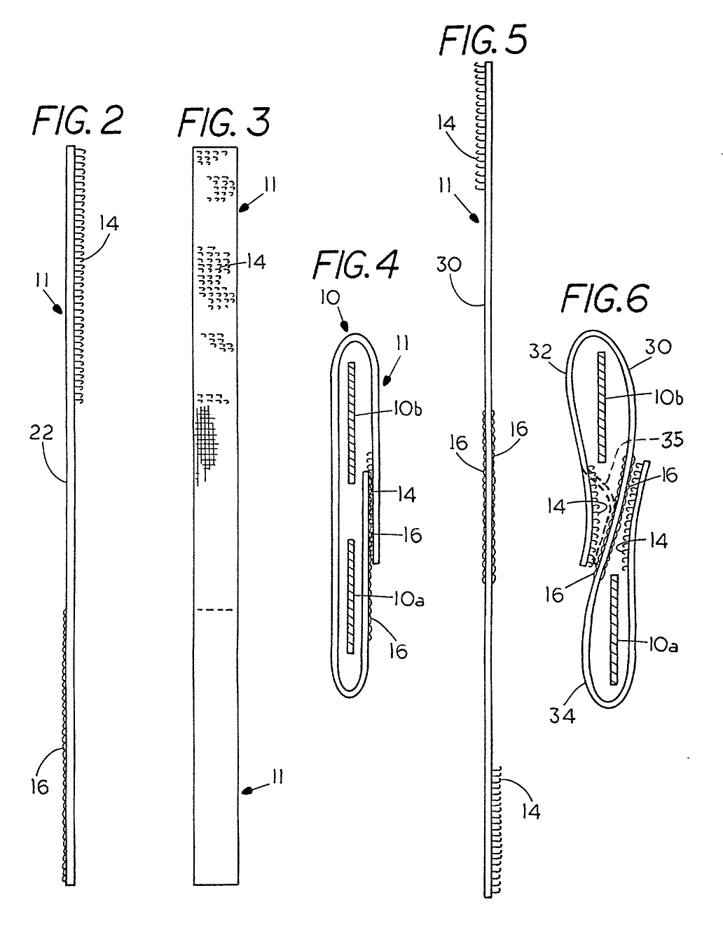

Refer now to FIGS. 2-4 which illustrate the positioning and retention band 11 in more detail. As can be seen in the figures, the band 11 comprises a strap formed from cloth, fabric webbing such as nylon webbing, leather or plastic sheet material 22 to which is attached, at least at the ends as shown in FIGS. 2 and 3, a releasable fastening means which in this case comprises a hook-and-loop fastener fabric, e.g., Velcro®, including hooks 14 on one surface of the band 11 and loops 16 on the other surface, so that when the band 11 is formed into a circle or loop (FIGS. 1 and 4), the hooks 14 and loops 16 will be in contact and thereby securely hold the band 11 in place around the lap belt 10a and shoulder belt 10b. By pulling the connected hook-and-loop fasteners 14, 16 apart, the user can then tighten or loosen the band 11 by reducing or increasing the diameter of the loop in the band. This enables the band 11 to be slid easily toward the right or left as seen in FIG. 1 to a selected position for holding the shoulder belt 10b in a location that is comfortable for the user. While a variety of strap materials such as cloth, leather, plastic, nonwoven fabric or woven belting fabric can be used for the strap 22, I prefer to employ a strong strap fabric such as nylon webbing having a width of about one inch and a length of about eight inches. Although the size of the hook-and-loop covered areas can be varied to suit the circumstances, in FIGS. 2-4 the hooks 14 cover about three-eighths of the length of the top side of the band material and the loops 16 cover about three-eighths of the length of the opposite side of the length of band material. This leaves a center portion of the band 11 free from the hook-and-loop fastener material. The hook-and-loop cloth can be secured to the strap 22 which comprises the body portion of the band 11 in any suitable manner, but is preferably secured by stitching. In a preferred form, the positioning and retention band 11 of strap or webbing material 22 has a layer of Velcro® hook material 14 which comprises a separate sheet of fabric and a layer of Velcro® loop material 16 also comprising a separate sheet of fabric that are stitched to the opposite sides of the strap material 22 at opposite ends thereof. Thus, in FIGS. 2-4 the layer of hooks 14 comprises a separate sheet of fabric bonded by stitches to one side of the strap 22, while the loops 16 comprise a second sheet of Velcro® stitched to the opposite side of the strap 22. The hook-and-loop fasteners 14, 16 provide a means of forming the band 11 into a loop with a variable diameter by changing the position of the Velcro® hook material 14 on the Velcro® loop material 16 where the ends overlap. The length and position of the hook-and-loop portions 14, 16 allow the size of the loop formed by the band 11 to be snug but loose enough around the lap or waist belt 10a and the shoulder belt 10b to enable the band 11 to be moved by sliding it to the left or right. As the band 11 is moved along the seatbelts 10a, 10b it keeps the two seatbelts in proximity with each other between the band 11 and the buckle 12. On the opposite side of the band 11, the belts 10a and 10b diverge from each other with the shoulder belt 10b extending upwardly to the elevated vehicular anchoring point 17 at an angle determined by the position of the band 11 that was selected by the user. The lap or waist belt 10a, however, extends from the band 11 laterally to the vehicular anchoring point at the bracket 15. The ability of the user to move the band 11 laterally allows the user to change both the angle and the direction of the shoulder belt 10b as it crosses the user's chest. This allows the user to travel in complete comfort by preventing any portion of the body, such as the user's neck, from being chafed.

At least the inside surface of the band 11 engaging the belts has a surface texture that provides sufficient friction with the lap belt 10a and shoulder belt 10b so that the band 11 remains in the position that has been selected by the user. When the belts 10a, 10b are formed from cloth webbing such as nylon webbing and the band 11 is also formed from cloth, enough friction is provided so that the band 11 will remain where it is placed by the user. The band should not have a slippery inner surface, and thus plastic film or sheet material is not preferred. If a plastic sheet is used, its inner surface should be covered by canvas, a woven strap material or stout cloth to prevent slippage. If there is any tendency to slip, the diameter of the loop formed in the band 11 can be reduced to provide a smaller loop by releasing the hook-and-loop connection 14, 16 and reattaching the ends after the loop has been reduced in size.

Many variations can be made in the invention. For example, the releasable hook-and-loop fasteners 14, 16 can be replaced, if desired, with other suitable releasable fasteners such as metal snaps, a zipper, or ordinary buttons and buttonholes. The hook-and-loop fasteners 14, 16, however, is highly preferred since it is easy to connect and allows an infinite number of size variations to be made in the diameter of the loop formed in the band 11. An important advantage of the present invention is that the adjustability of the size of the loop in the band 11 enables the band 11 to fit loose enough around the belts 10a, 10b to slide thereon without slipping because friction with the belt 10 is controlled and yet it is too small to pass over the housing 12c of the buckle 12 when not in use.

Refer now to FIGS. 5 and 6 which illustrate another form of band in accordance with the invention. In this figure, the band 11 is formed from a longer flexible piece of material 30, e.g., of nylon webbing with Velcro® hook material 14 attached on opposite sides of both ends and a center portion having Velcro® loop material secured on both sides at 16. The Velcro® hook-and-loop material 14, 16 can be secured in any suitable manner, e.g., by staples, adhesive, heat sealing or other fasteners, but is preferably secured to the material 30 by means of stitching.

The manner of using the band 30 is illustrated in FIG. 6 which shows how an upper loop 32 encircles the shoulder belt 10b and a lower loop 34 encircles the lap belt 10a, both Velcro® hook sections 14 being secured to the loop material 16 at the center of the band 30. This design may require a somewhat longer strap than that of FIGS. 1-4. However, it has the feature of separately enclosing the belts 10a and 10b as can be seen in FIG. 6.

In a modified form of the invention shown in FIG. 6, the construction is the same as already described, except an end portion 35 of the piece of strap material 30 is permanently secured, e.g., by means of stitching to the center portion of the strap material 30 instead of being removably connected. In this case, the upper loop 32 is a permanent loop which encircles the shoulder belt 10b. Thus, the permanently secured end 35 of the material 30 connects the strap material to the belt while the lower loop 34 is defined by a piece of extending strap material that has a free end which is releasably connected to an adjacent portion of the strap, in this case the center of the strap material, e.g., by a section of hook material 14 at one end of the strap and loop material 16 at the center of the strap material 30, both being on the same surface to form a releasable fastener for the lower loop 34 so that it encircles the lap belt 10a.

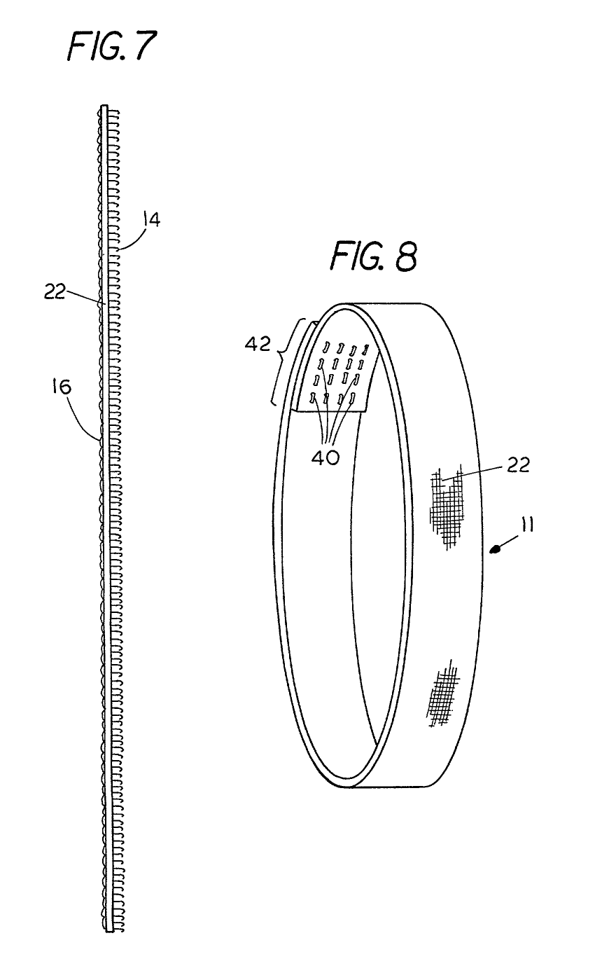

Refer now to FIG. 7 which illustrates another form of band in accordance with the invention. In FIG. 7, the strap 22 is similar to that shown in FIGS. 2-4. However, in this case the hooks 14 cover one entire side of the strap 22 while the loops 16 of the hook-and-loop fastener cover the entire opposite side. The fasteners 14, 16 can be secured to the strap 22 in any suitable manner as already described, e.g., by adhesive, heat sealing, stitching, staples or other fastening means. The fasteners 14, 16 can also be woven directly into the strap material 22 as a part thereof if desired. The band 11 in FIG. 7 is also preferably about one inch wide by about eight inches long, with the hooks 14 and loops 16 covering the entire surface on opposite sides of the strap 22. The strap of FIG. 7 allows the loop forming the band 11 to be made as large or as small as desired, since there are no portions of the strap 22 that are not covered by the hook-and-loop fasteners 14, 16. It can also be seen that the adjustable fastening, such as the hook-and-loop fastener 14, 16, enables the band 11 to fit a wide range of seatbelt sizes and allows the band 11 to be switched from one seatbelt to another seatbelt. The size of the band 11 can be varied widely, for example from about one-quarter inch wide to about six inches wide or more, and the length can range up to 24 inches or more.

Refer now to FIG. 8 which illustrates another form of positioning and retention band 11 in which the releasable hook-and-loop or Velcro® fastener has been replaced by permanent stitching 40 in an area 42 where the ends of the strap material 22 overlap each other. The size of the buckle 12 is related to the size of the loop of FIG. 8, with the loop being smaller than the buckle so that the band 11 cannot slide over the buckle 12. This feature can be thought of as a means as a part of the passenger restraint for maintaining the band 11 connected to the belt while remaining slidable thereon. The form of the invention shown in FIG. 8 is particularly advantageous when the invention is provided by the vehicle manufacturer, e.g., automobile manufacturer, as original equipment when the car is sold. In this case, the exact size and orientation of the belts 10a, 10b will be known as will be the frictional characteristics of the surface of the belts. Therefore the inner surface of the band 11 of FIG. 8 can be provided with the proper frictional characteristic to just enable the band 11 to be slid to the left or right as required without binding and yet reliably remain in the selected position without slipping. The band 11 cannot be lost by passing over the buckle.

Many variations of the present invention within the scope of the appended claims will be apparent to those skilled in the art once the principles described herein are understood.

What is claimed is:

1. A passenger restraint for a vehicle, comprising:
a lap belt and a shoulder belt, said lap belt extending from a first vehicular anchoring point to a buckle and said shoulder belt extending from said buckle to an elevated vehicular anchoring point, a flexible positioning and retaining band formed into a loop for encircling both of the belts in a lap area and being slidable on a generally horizontal axis extending from right to left across the lap of the user to hold the belts proximate to one another between the band and the buckle,
said belts diverging from one another on the opposite side of the band from the buckle such that the shoulder belt extends upwardly and diagonally to said elevated vehicular anchoring point and the lap belt extends laterally from the band to the first vehicular anchoring point,
said band has a surface texture at least on a side thereof in contact with the belts to provide sufficient friction with the belts such that the band remains in a position thereon that is selected by the user to maintain an angle of inclination of the shoulder belt that is comfortable for the user and in which the shoulder belt does not chafe the neck or other parts of the body of the user.

2. The passenger restraint of claim 1 wherein the positioning and retaining band is a strap having a pair of ends and a releasable fastener means is provided at least at the ends of the strap for securing the ends of the strap to one another in selected positions to vary the diameter of the loop forming said band.

3. The passenger restraint of claim 2 wherein the releasable fastener means comprises a hook-and-loop fastener.

4. The passenger restraint of claim 3 wherein the hook-and-loop fastener comprises a sheet of hook material connected to one surface of said strap proximate to one end thereof and a sheet of loop material connected to the opposite side of said strap proximate an opposite end thereof.

5. The passenger restraint of claim 3 wherein the hook-and-loop fastener comprises a sheet of hook material covering the entire surface of said strap proximate to one end thereof and a sheet of loop material covering the entire opposite side of said strap.

6. The passenger restraint of claim 3 wherein said hook-and-loop fastener comprises hook material on opposite surfaces of the strap proximate opposite ends thereof and loop material secured on opposite sides of the strap at the center thereof.

7. The passenger restraint of claim 1 wherein the band is a strap having a pair of ends and the ends are permanently secured in overlapping relationship to form said band into a loop of a fixed diameter.

8. The passenger restraint of claim 1 wherein the band comprises a flexible strap selected from the group consisting of woven belting fabric, leather, plastic and non-woven material, and the strap has dimensions on the order of about one inch wide by about eight inches in length.

9. The passenger restraint of claim 8 wherein the strap has a releasable fastener on one side of one end thereof comprising hook material about one inch in width by about three inches in length and on the opposite side of the opposite end thereof a strip of loop fabric of about one inch in width and three inches in length, and remaining portions of the surface of the strap being devoid of the releasable fastening material.

10. The passenger restraint of claim 1 wherein the band has a pair of separable ends that are secured together by means of snaps, buttons and buttonholes, or a zipper.

11. The passenger restraint of claim 7 wherein the ends of the strap are secured together by a permanent fastening selected from the group consisting of sewing, stitching, gluing, stapling and heat sealing.

12. The passenger restraint of claim 1 wherein the band comprises a strap to form at least one loop of an adjustably selected size to encircle the lap belt and the shoulder belt.

13. The passenger restraint according to claim 1 wherein the band includes two loops including an upper loop enclosing the shoulder belt and a lower loop enclosing the lap belt.

14. The restraint of claim 13 wherein each of the loops is adjustable in size.

15. The restraint of claim 14 wherein an end portion of each of the loops is releasably connected to a portion of the band by a releasable fastener, and each of the loops in the band encircles one of the belts.

16. A passenger restraint for a vehicle having a lap belt and a shoulder belt, said lap belt extending from a first vehicular anchoring point to a buckle and said shoulder belt extending from said buckle to an elevated vehicular anchoring point, said restraint including:
a flexible positioning and retaining band formed into a loop for encircling both of the belts in a lap area and being slidable on a generally horizontal axis extending from right to left across the lap of the user to hold the belts proximate to one another between the band and the buckle,
said belts diverging from one another on the opposite side of the band from the buckle such that the shoulder belt extends upwardly and diagonally to said elevated vehicular anchoring point and the lap belt extends laterally from the band to the first vehicular anchoring point,
said band has a surface texture at least on a side thereof in contact with the belts to provide sufficient friction with the belts such that the band remains in a position thereon that is selected by the user to maintain an angle of inclination of the shoulder belt that is comfortable for the user and in which the shoulder belt does not chafe the neck or other parts of the body of the user.

17. The passenger restraint of claim 16 wherein the positioning and retaining band is a strap having a pair of ends and a releasable fastener means is provided at least at the ends of the strap for securing the ends of the strap to one another in selected positions to vary the diameter of the loop forming said band.

18. The passenger restraint of claim 17 wherein the releasable fastener means comprises a hook-and-loop fastener.

19. The passenger restraint of claim 16 wherein the band is a strap having a pair of ends and the ends are permanently secured in overlapping relationship to form said band into a loop of a fixed diameter.

20. The restraint of claim 13 wherein one of said loops encircles one of the belts and has an end portion that is permanently secured to a portion of said band and the remaining portion of said band defines an extending portion that has a releasable fastening means between a free end thereof and an adjacent portion of the band to form a releasable and removable loop that encircles another one of said belts.

21. The passenger restraint of claim 20 wherein the releasable fastening means comprises a hook-and-loop fastener.

22. The passenger restraint of claim 19 wherein the size of the buckle is related to the size of the loop in the band, with the loop being smaller than the buckle so that the band cannot slide over the buckle.

23. The passenger restraint of claim 1 also including a means as a part of the passenger restraint for maintaining the band 11 connected to the belt while remaining slidable thereon.

24. The passenger restraint of claim 16 also including a means as a part of the passenger restraint for maintaining the band 11 connected to the belt while remaining slidable thereon.
